(19) United States
(12) Patent Application Publication
(10) Pub. No.: US 2014/0200110 A1
(43) Pub. Date: Jul. 17, 2014

(54) CONTINUOUSLY VARIABLE TRANSMISSION

(71) Applicant: Tatsuya Matsunami, Nisshin-shi (JP)

(72) Inventor: Tatsuya Matsunami, Nisshin-shi (JP)

(73) Assignee: TOYOTA JIDOSHA KABUSHIKI KAISHA, Toyota-shi (JP)

(21) Appl. No.: 14/124,162

(22) PCT Filed: Jun. 10, 2011
(86) PCT No.: PCT/JP2011/063347

§ 371 Date: Dec. 5, 2013

(51) Int. Cl. F16H 15/40

(52) U.S. Cl. CPC F16H 15/40
USPC 476/54

(57) ABSTRACT

A continuously variable transmission includes each planetary ball sandwiched between first and second rotation members on a shaft and a sun roller; a first carrier configured to be rotatable relatively with the shaft as a center and formed with a first guide portion that guides one projection of each support shaft of each planetary ball in a radial direction; a second carrier formed with a second guide portion that guides the other projection of each support shaft in the radial direction; and an iris plate configured to include a throttle portion that holds one projection of the support shaft at an intersection point with the first guide portion formed when seen in an axis line direction, the intersection point being moved in the radial direction with the rotation.

### FIELD

The present invention relates to a continuously variable transmission, including a plurality of rotation elements having a common rotation shaft and a rolling member radially arranged in plurals with respect to the rotation shaft, for continuously changing a transmission gear ratio between input and output by tilting each rolling member sandwiched by two rotation elements.

### BACKGROUND

The so-called traction planetary gear mechanism is conventionally known for this type of continuously variable transmission. For example, the traction planetary gear mechanism may include a transmission shaft to become the rotation center; a plurality of relatively rotatable rotation elements having a center axis of the transmission shaft as a first rotation center axis; a rolling member having another second rotation center axis parallel to the first rotation center axis and being radially arranged in plurals with the first rotation center axis as the center; a support shaft for spinning and supporting the rolling element; and a holding member, fixed with respect to the transmission shaft, for holding the rolling member through a projecting portion from the rolling member of the support shaft. In such traction planetary gear mechanism, each rolling member is sandwiched by the first rotation element and the second rotation element, which are arranged facing each other, each rolling member is arranged on an outer circumferential surface of a third rotation element, and the transmission gear ratio is continuously changed by tilting the rolling member.

For example, patent literature 1 below discloses this type of continuously variable transmission. The continuously variable transmission of patent literature 1 includes an iris plate that tilts the rolling member through the support shaft by its rotation; a motor serving as a drive source that rotates the iris plate; a support plate (holding member) that causes the rolling member to generate skew through the support shaft by its rotation; and a motor serving as a drive source different from the above for rotating the support plate. The iris plate includes an arc-shaped iris groove to which the support shaft is inserted. The support plate includes a radial guide portion to which the support shaft is inserted. The continuously variable transmission applies force on the support shaft from the iris groove by the rotation of the iris plate to tilt the rolling member, but the force applied on the support shaft from the iris groove can be reduced since the rolling member is caused to generate skew by the rotation of the support plate. That is, the continuously variable transmission reduces the energy (energy required for gear shift) required to tilt the rolling member by causing the rolling member to generate skew by the rotation of the support plate, and assists the rotation of the iris plate by the motor. Patent literature 2 discloses one example of the continuously variable transmission that includes a cam for moving a sun roller (third rotation element) in the axis line direction by its rotation, where the rolling member is tilted by the movement of the sun roller. Such continuously variable transmission includes a spline that rotates a carrier (holding member) in conjunction with the rotation of the cam.

### CITATION LIST

### Patent Literature

Patent Literature 1: Specification of US patent application Laid-open No. 2009/0082169
Patent Literature 2: Japanese translation of PCT international application No. 2010-532454

### SUMMARY

### Technical Problem

The continuously variable transmission of patent literature 1 also includes another motor for rotating the support plate and not only the motor for rotating the iris motor. Therefore, the continuously variable transmission can reduce the energy for gear shift of the iris plate but may increase the build of the transmission by the plurality of motors.

The purposes of the present invention are to improve the drawbacks of the conventional example and to provide a continuously variable transmission capable of suppressing the enlargement of the build while reducing the energy for gear shift.

### Solution to Problem

In order to achieve the above mentioned object, a continuously variable transmission according to the present invention includes a transmission shaft as a fixing shaft serving as a rotation center; a first rotation element and a second rotation element configured to be rotatable relatively, arranged facing each other on the transmission shaft and have a common first rotation center axis; a rolling member configured to have a second rotation center axis parallel to the first rotation center axis, arranged radially in plurals with the first rotation center axis as a center, and sandwiched between the first rotation element and the second rotation element; a support shaft of the rolling member configured to have the second rotation center axis and both ends of the support shaft projecting out from the rolling member; a third rotation element configured to arrange the each rolling member on an outer circumferential surface, and arranged to be rotatable relatively with respect to the transmission shaft as well as the first rotation element and the second rotation element; a first holding member arranged to be rotatable relatively with the first rotation center axis as the center with respect to the transmission shaft, and formed with a first guide portion that guides one projection of the each support shaft in a radial direction; a second holding member fixed to the transmission shaft and formed with a second guide portion that guides the other projection of the each support shaft in the radial direction; a tilt element configured to include a throttle portion that has an intersection point intersecting with the first guide portion when seen in an axis line direction and that holds one projection of the support shaft at the intersection point, and configured to move the intersection point in the radial direction by rotating relatively with the first rotation center axis as the center with respect to the transmission shaft; an actuator configured to rotate relatively the tilt element with respect to the transmission shaft; and a torque transmitting unit configured to generate a transmission torque between the first holding member and the tilt element corresponding to a relative rotation speed between the first holding member and the tilt element.

Here, it is desirable that the torque transmitting unit sets a transmission torque greater than a product of a force to the first holding member from the support shaft corresponding to an input torque and an acting radius of the force.

### Advantageous Effects of Invention

In the continuously variable transmission according to the present invention, the transmission torque of the torque transmitting unit is transmitted to the first holding member by rotating the tilt element with the actuator, thus rotating the first holding member. That is, according to the continuously variable transmission, the dedicated actuator for the rotation of the first holding member does not need to be prepared as in the conventional art, and the first holding member can also be rotated with only the actuator for rotating the tilt element by arranging the torque transmitting unit. Therefore, the continuously variable transmission can achieve both reduction of gear shifting energy necessary for gear shift and miniaturization of the transmission.

### BRIEF DESCRIPTION OF DRAWINGS

FIG. 1 is a partial cross-sectional view illustrating a configuration of an example of a continuously variable transmission according to the present invention.

FIG. 2 is a view explaining a first carrier, and is a cross-sectional view taken along line X-X of FIG. 1.

FIG. 3 is a view explaining a second carrier.

FIG. 4 is a view explaining an iris plate.

FIG. 5 is a view explaining a force generated by an input torque and a rotation direction of the iris plate at the time of gear shift to the decelerating side.

FIG. 6 is a view illustrating one example of torque transmission property of a torque transmitting unit.

FIG. 7 is a view explaining a skew force at the time of gear shift to the decelerating side.

FIG. 8 is a view explaining a force generated by the input torque and a rotation direction of the iris plate at the time of gear shift to the speed increasing side.

FIG. 9 is a view explaining a skew force at the time of gear shift to the speed increasing side.

FIG. 10 is a view illustrating one example of a property of an elastic member.

### DESCRIPTION OF EMBODIMENTS

An example of the continuously variable transmission according to the present invention will be hereinafter explained in detail based on the drawings. It should be noted that the present invention is not to be limited by the example.

### Example

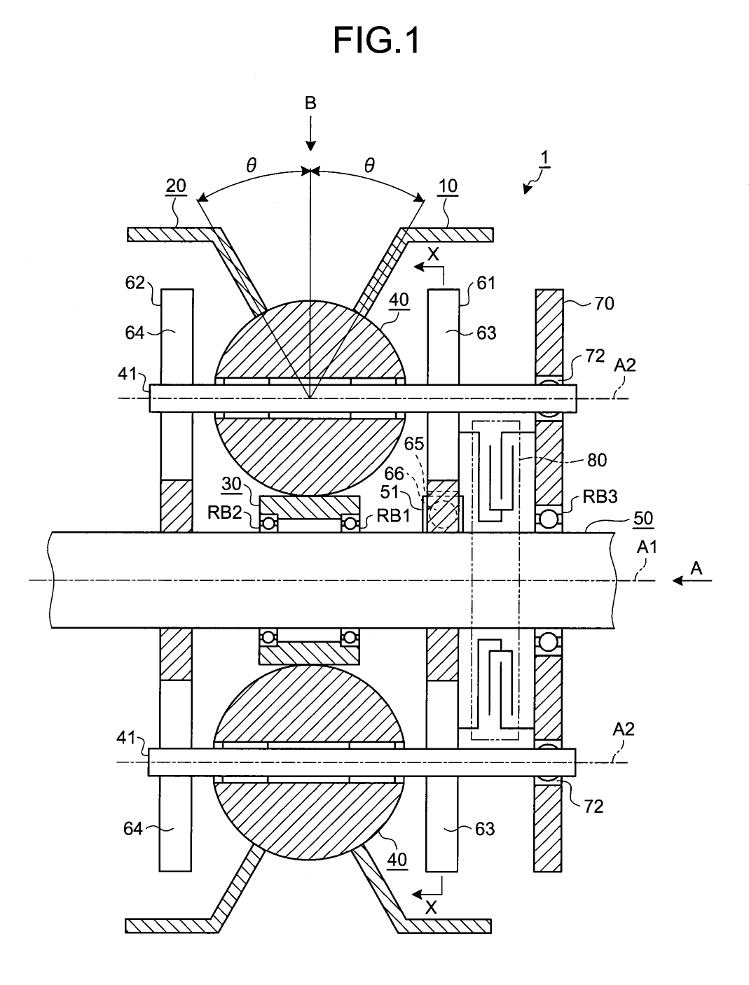

An example of the continuously variable transmission according to the present invention will be explained based on FIG. 1 to FIG. 10.

First, one example of the continuously variable transmission of the present example will be described using FIG. 1. Reference sign 1 of FIG. 1 indicates the continuously variable transmission of the present example.

A continuously variable transmission mechanism, which configures the main part of the continuously variable transmission 1, is a so-called traction planetary gear mechanism including first to third rotation elements 10, 20, 30 that can relatively rotate with each other having a common first rotation center axis A1; a rolling member 40 radially arranged in plurals with the first rotation center axis A1 as the center and having another second rotation center axis A2 parallel to the first rotation center axis A1 at a reference position, to be described later; a shaft 50 serving as a transmission shaft arranged at the rotation center of the first to third rotation elements 10, 20, 30; and first and second holding members 61, 62 that hold the respective rolling member 40 in a freely tilting manner. The continuously variable transmission 1 changes the transmission gear ratio γ between input and output by inclining the second rotation center axis A2 with respect to the first rotation center axis A1 and tilting the rolling member 40. Hereinafter, unless particularly stated, a direction along the first rotation center axis A1 and the second rotation center axis A2 is referred to as an axis line direction, and a direction about the first rotation center axis A1 is referred to as a circumferential direction. Furthermore, a direction orthogonal to the first rotation center axis A1 is referred to as a radial direction, where the side toward the inner side is referred to as radially inner side and the side toward the outer side is referred to as radially outer side.

In such continuously variable transmission 1, the first rotation element 10 and the second rotation element 20, which are arranged facing each other, sandwich the respective rolling member 40, the respective rolling member 40 is arranged on the outer circumferential surface of the third rotation element 30, and the torque is transmitted through each rolling member 40 among the first rotation element 10, the second rotation element 20, and the third rotation element 30. For example, in the continuously variable transmission 1, one of the first to third rotation elements 10, 20, 30 may be an input section of the torque (power), and at least one of the remaining rotation elements may be an output section of the torque. Thus, in the continuously variable transmission 1, the ratio of the rotation speed (number of revolutions) between one of the rotation elements to become the input section and one of the rotation elements to become the output section becomes the transmission gear ratio γ. For example, the continuously variable transmission 1 is arranged on a power transmission path of a vehicle. In this case, the input section is coupled to a power source side such as engine, motor, and the like, and the output section is coupled to a drive wheel side. In the continuously variable transmission 1, the rotation operation of each rotation element of when the torque is input to the rotation element serving as the input section is referred to as positive drive, and the rotation operation of each rotation element of when the torque in the reverse direction from the time of positive drive is input to the rotation element serving as the output section is referred to as reverse drive. For example, the continuously variable transmission 1 is in positive drive when the torque is being input to the rotation element serving as the input section from the power source side to rotate the relevant rotation element as in acceleration and the like, and is in reverse drive when the torque in the reverse direction from the time of positive drive is being input to the rotating rotation element serving as the output section from the drive wheel side as in deceleration and the like, according to the above illustration of the vehicle.

The continuously variable transmission 1 presses at least one of the first or second rotation element 10, 20 against the rolling member 40 to generate an appropriate tangential force (traction force) between the first to third rotation elements 10, 20, 30 and the rolling member 40 and allow the transmission of torque in between. The continuously variable transmission 1 also tilts the respective rolling member 40 on a tilt plane including its second rotation center axis A2 and the first rotation center axis A1, and changes the ratio of the rotation speed (number of revolutions) of the first rotation element 10 and the second rotation element 20 to change the ratio of the rotation speed (number of revolutions) between input and output.

In such continuously variable transmission 1, the first and second rotation elements 10, 20 provide the function of ring gear in the planetary gear mechanism. The third rotation element 30 functions as the sun roller in the traction planetary gear mechanism. The rolling member 40 functions as a ball type pinion in the traction planetary gear mechanism, and the first and second holding members 61, 62 function as carriers. Hereinafter, the first and second rotation elements 10, 20 are respectively referred to as “first and second rotation members 10, 20”. The third rotation element 30 is referred to as “sun roller 30”, and the rolling member 40 is referred to as “planetary ball 40”. The first and second holding members 61, 62 are referred to as “first carrier 61” and “second carrier 62”, respectively. In the following illustration, the second carrier 62 is assumed as a fixed element and is fixed to the shaft 50.

The shaft 50 is fixed to a fixing unit of the continuously variable transmission 1 in a housing, vehicle body, and the like (not illustrated), and is a circular column shaped or cylindrical shaped fixing shaft configured so as not to relatively rotate with respect to the fixing unit.

The first and second rotation members 10, 20 are disk members (disk) or circular ring members (ring), which center axis is coincided with the first rotation center axis A1, and are arranged to face each other in the axis line direction and to sandwich each planetary ball 40. In this illustration, both rotation members are circular ring members.

The first and second rotation members 10, 20 have a contacting surface that makes contact with the outer circumferential curved surface on the radially outer side of each planetary ball 40, to be described in detail later. The respective contacting surface is, for example, formed to shapes such as a concave arc surface having a curvature equivalent to the curvature of the outer circumferential curved surface of the planetary ball 40, a concave arc surface having a curvature different from the curvature of the outer circumferential curved surface, a projection arc surface, a plane, or the like. The respective contacting surfaces are formed herein so that the distance from the first rotation center axis A1 to the contacting point with each planetary ball 40 is the same length in a state of reference position, to be described later, and the respective contacting angles θ of the first and second rotation members 10, 20 respect to each planetary ball 40 is also formed to the same angle. The contacting angle θ is an angle from the reference to the contacting point with each planetary ball 40. The radial direction is set as the reference herein. The respective contacting surfaces make point contact or area contact with respect to the outer circumferential curved surface of the planetary ball 40. The respective contacting surfaces are formed such that a force (normal force) in the diagonal direction is applied on the radially inner side on the planetary ball 40 when a force (pressing force) in the axis line direction is applied from the first and second rotation members 10, 20 toward the planetary ball 40.

In the illustration, the first rotation member 10 acts as a torque input section at the time of positive drive of the continuously variable transmission 1, and the second rotation member 20 acts as a torque output section at the time of positive drive of the continuously variable transmission 1. Therefore, an input shaft (not illustrated) is coupled to the first rotation member 10, and an output shaft (not illustrated) is coupled to the second rotation member 20. The input shaft and the output shaft can perform a relative rotation in the circumferential direction with respect to the shaft 50. The continuously variable transmission 1 may use that provided as the input shaft for the output shaft, and that provided as the output shaft for the input shaft.

An axial force generating unit (not illustrated) that generates an axial force is arranged between the input shaft and the first rotation member 10. A torque cam can be assumed for the axial force generating unit. Therefore, the axial force generating unit can generate the axial force between the input shaft and the first rotation member 10 and transmit the rotation torque by engaging an engagement member on the input shaft side and an engagement member on the first rotation member 10 side to integrally rotate the same. The axial force generated by the axial force generating unit is transmitted to the first rotation member 10 and the second rotation member 20, and becomes the pressing force of when the rotation members press each planetary ball 40. The axial force generating unit may be arranged between the output shaft and the second rotation member 20 instead of the first rotation member 10 side or in addition to the first rotation member 10 side.

The sun roller 30 is arranged concentrically with the shaft 50 to perform a relative rotation in the circumferential direction with respect to the shaft 50. Radial bearings RB1, RB2 are arranged between the sun roller 30 and the shaft 50. A plurality of planetary balls 40 is radially arranged at substantially equal interval on the outer circumferential surface of the sun roller 30. Therefore, the outer circumferential surface of the sun roller 30 becomes a rolling surface of when the planetary ball 40 spins. The sun roller 30 can roll (spin) the respective planetary ball 40 with its rotation operation, and can also rotate with the rolling operation (spinning operation) of the respective planetary ball 40. In such sun roller 30, a lock member such as a snap ring, for example, is arranged on the side surfaces of the radial bearings RB1, RB2 so as not to move in the axis line direction with respect to the shaft 50.

The planetary ball 40 is a rolling member that rolls on the outer circumferential surface of the sun roller 30. The planetary ball 40 is preferably a complete spherical body, but may be at least formed to a sphere in the rolling direction, for example, formed to have an elliptical cross-section such as a rugby ball. The planetary ball 40 is supported rotatably by a support shaft 41 passed through the center. For example, the planetary ball 40 can relatively rotate (i.e., spin) with respect to the support shaft 41 having the second rotation center axis A2 as a rotation axis by the bearing arranged in between the outer circumferential surface of the support shaft 41. Therefore, the planetary ball 40 can roll on the outer circumferential surface of the sun roller 30 with the support shaft 41 as the center. Both ends of the support shaft 41 are projected out from the planetary ball 40.

The position that becomes the reference of the support shaft 41 is the position where the second rotation center axis A2 becomes parallel to the first rotation center axis A1, as illustrated in FIG. 1. The support shaft 41 can oscillate (tilt) with the planetary ball 40 between the reference position and the position inclined therefrom in a tilt plane including its rotation center axis (second rotation center axis A2) and the first rotation center axis A1 formed at the reference position. The tilt is carried out with the center of the planetary ball 40 as the fulcrum in the tilt plane.

The first and second carriers 61, 62 are arranged facing each other on the shaft 50, and hold the support shaft 41 so as not to inhibit the tilting operation of each planetary ball 40 arranged in between. The respective projections of the support shaft 41 projecting out from the planetary ball 40 are held one by the first carrier 61 and the other by the second carrier 62. The first and second carriers 61, 62 are disc members, which center axes are coincided with the first rotation center axis A1, for example.

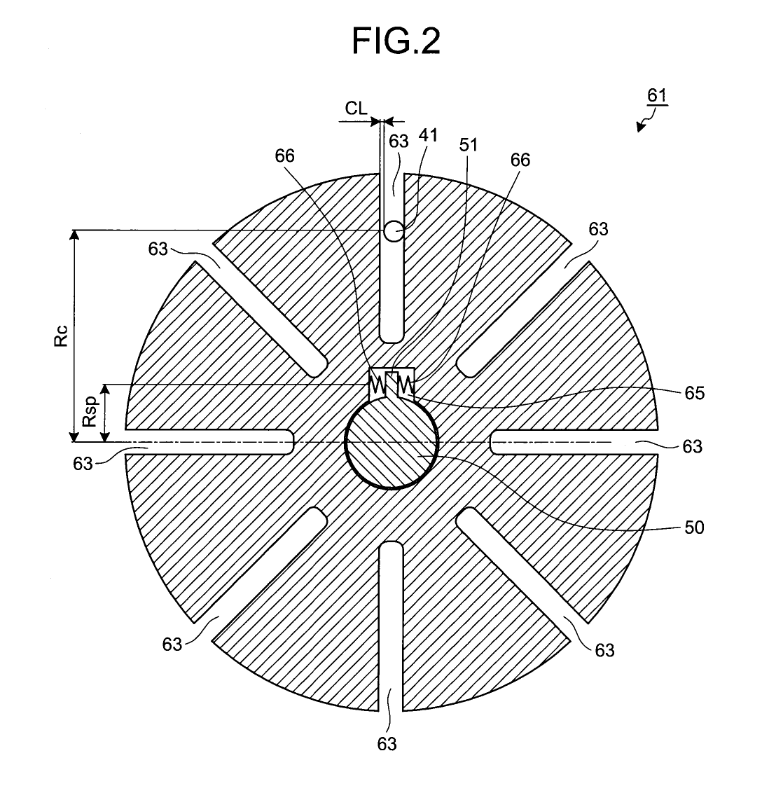

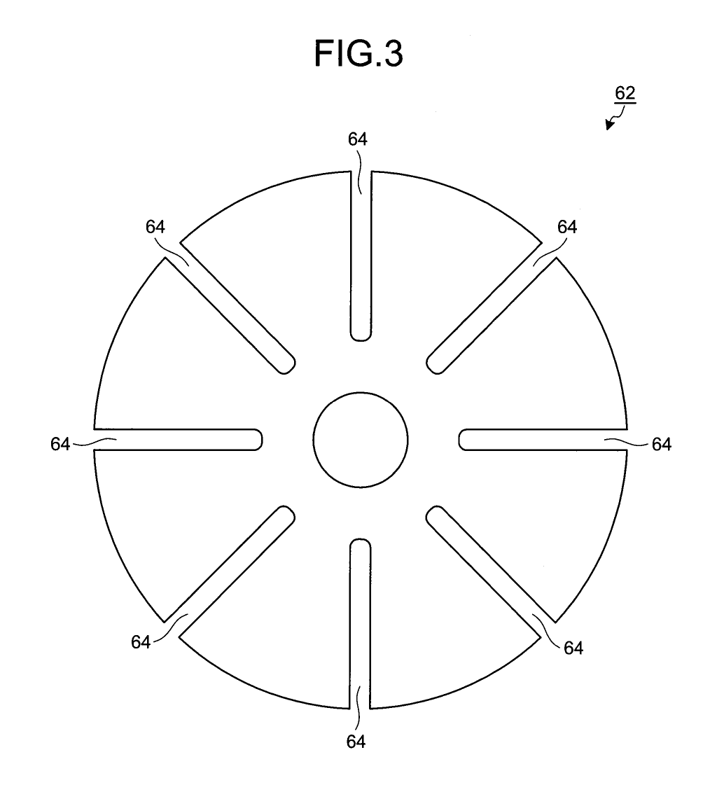

The continuously variable transmission 1 includes first and second guide portions 63, 64 for guiding the support shaft 41 in the tilting direction when tilting the respective planetary balls 40. In the illustration, the first and second guide portions 63, 64 are arranged on the first and second carriers 61, 62, respectively. The first and second guide portions 63, 64 are radial guide grooves or guide holes that guide the support shaft 41 projecting out from the planetary ball 40 toward the tilting direction, and are formed for every planetary ball 40 at the respective opposing portions of the first and second carriers 61, 62 (FIGS. 2, 3). That is, the first and second guide portions 63, 64 are all radially formed when seen in the axis line direction (e.g., direction of the arrow A of FIG. 1).

In the illustration, the first carrier 61 is arranged between each planetary ball 40 and an iris plate 70, to be described later. Thus, the first guide portion 63 of the first carrier 61 is passed through the support shaft 41 as a guide hole. The second guide portion 64 of one second carrier 62 may be the guide groove or the guide hole. The first and second guide portions 63, 64 assume the circumferential direction of the first and second carriers 61, 62 as the width. The first and second guide portions 63, 64 do not inhibit the tilting operation of the planetary ball 40 by widening the width to be greater than the diameter of the support shaft 41 (outer shape if roller bearing and the like is interposed).

In the illustration, the first carrier 61 arranged close to the iris plate 70 is attached to relatively rotate with respect to the shaft 50, and the second carrier 62 arranged at a position farther away from the iris plate 70 than the first carrier 61 is fixed to the shaft 50.

The first carrier 61 has a groove portion 65 formed on the inner circumference side. In the illustration, one groove portion 65 is formed as illustrated in FIG. 2, but the groove portion 65 may be formed in plurals on a diagonal line or radially with the first rotation center axis A1 as the center. A projection 51 is arranged at a position corresponding to the groove portion 65 on the outer circumferential surface of the shaft 50. The first carrier 61 is attached to the shaft 50 with the projection 51 inserted into the groove portion 65. The wall surface on the radially inner side of the groove portion 65 and the wall surface on the radially outer side of the projection 51 are formed so as not to contact each other. Furthermore, a clearance is formed between the respective wall surfaces in the circumferential direction of the groove portion 65 and the respective wall surfaces in the circumferential direction of the projection 51.

An elastic member 66 such as a helical spring is arranged in the respective clearance. The respective elastic member 66 is arranged to expand and contract in the circumferential direction or substantially circumferential direction, and holds the first carrier 61 at a neutral position if a circumferential force is not applied on the first carrier 61. The neutral position is the position where the first guide portion 63 and the second guide portion 64 completely overlap when seen in the axis line direction if the shapes in the width direction and the radial direction of the first and second guide portions 63, 64 are the same, and is a state in which each clearance of the support shaft 41 and the respective wall surface in the width direction of the first guide portion 63 is uniform.

The second carrier 62 cannot relatively rotate in the circumferential direction nor relatively move in the axis line direction with respect to the shaft 50 since the inner circumferential surface side of the second carrier 62 is fixed to the outer circumferential surface side of the shaft 50 by fitting, press fitting, and the like.

In the continuously variable transmission 1, the first rotation member 10 and the second rotation member 20 rotate at the same rotation speed (same number of revolutions) when the tilt angle of the respective planetary ball 40 is the reference position, that is, zero degree. That is, in this case, the rotation ratio (ratio of the rotation speed or the number of revolutions) of the first rotation member 10 and the second rotation member 20 becomes one, and the transmission gear ratio γ becomes one. When the respective planetary ball 40 is tilted from the reference position, the distance from the center axis (second rotation center axis A2) of the support shaft 41 to the contacting point with the first rotation member 10 changes, and the distance from the center axis of the support shaft 41 to the contacting point with the second rotation member 20 changes. Thus, either one of the first rotation member 10 or the second rotation member 20 rotates at a higher speed than at the reference position and the other rotates at a lower speed. For example, the second rotation member 20 is in low rotation (decelerating) than the first rotation member 10 when the planetary ball 40 is tilted to one side, and is in high rotation (speed increasing) than the first rotation member 10 when tilted to the other side. Therefore, in the continuously variable transmission 1, the rotation ratio (transmission gear ratio γ) between the first rotation member 10 and the second rotation member 20 can be continuously changed by changing the tilt angle. When the transmission gear ratio γ is in speed increasing (γ<1), the planetary ball 40 on the upper side in FIG. 1 is tilted in the counterclockwise direction in the plane of drawing than the reference position and the planetary ball 40 on the lower side is tilted in the clockwise direction in the plane of drawing than the reference position. Furthermore, when the transmission gear ratio γ is in decelerating (γ>1), the planetary ball 40 on the upper side in FIG. 1 is tilted in the clockwise direction in the plane of drawing than the reference position and the planetary ball 40 on the lower side is tilted in the counterclockwise direction in the plane of drawing than the reference position.

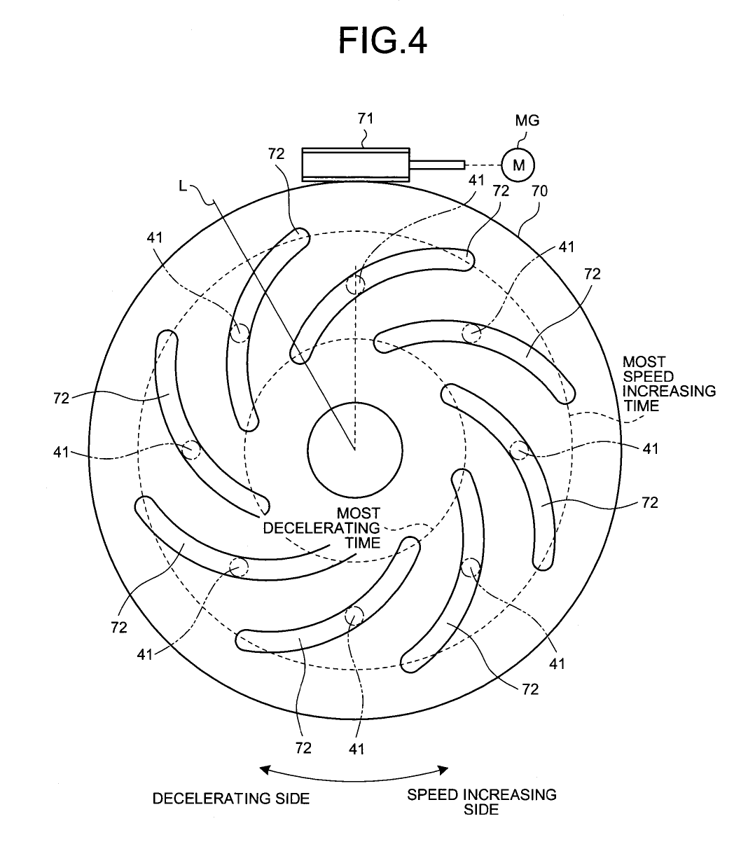

The continuously variable transmission 1 includes a transmission for changing the transmission gear ratio γ. The transmission gear ratio γ changes with change in the tilt angle of the planetary ball 40, and hence a tilt device that tilts the respective planetary ball 40 is used for the transmission. The transmission includes a disk-shaped iris plate (tilt element) 70 herein. The iris plate 70 is attached to the shaft 50 by way of a radial bearing RB3 on the radially inner side, and can relatively rotate with the first rotation center axis A1 as the center with respect to the shaft 50. An actuator serving as a drive source of the iris plate 70 is used for the relative rotation. A motor MG illustrated in FIG. 4 is arranged herein. The drive force of the motor MG is transmitted to the outer circumference portion of the iris plate 70 through a power transmission unit such as a worm gear 71, for example.

The iris plate 70 is arranged at any place of the outer side of the first carrier 61 (side on which each planetary ball 40 is not arranged in the axis line direction), the outer side of the second carrier 62 (side on which each planetary ball 40 is not arranged in the axis line direction), between the first carrier 61 and each planetary ball 40, or between the second carrier 62 and each planetary ball 40. The iris plate 70 is arranged on the outer side of the first carrier 61 herein.

The iris plate 70 is formed with a throttle portion 72 to which one projection of the support shaft 41 is inserted. The throttle portion 72 has a shape that deviates in the circumferential direction with respect to the radial direction from the radially inner side toward the radially outer side, and is a so-called throttle hole (iris hole) or a throttle groove (iris groove). The throttle hole is illustrated herein. Specifically, the throttle portion 72 has an arc-shape that separates away from the reference line L in the circumferential direction from the radially inner side toward the radially outer side assuming the radial direction having the end in the radially inner side as a starting point as the reference line L (FIG. 4). The throttle portion 72 includes an intersection point that intersects with the first guide portion 63 when seen in the axis line direction, and holds one projection of the support shaft 41 at the intersection point. The intersection point moves in the radial direction with the rotation of the iris plate 70. FIG. 4 is a view of the iris plate 70 seen in the direction of the arrow A of FIG. 1.

One projection of the support shaft 41 moves toward the center side of the iris plate 70 along the throttle portion 72 when the iris plate 70 rotates in the clockwise direction in the plane of drawing in FIG. 4. In this case, the one projection inserted into the throttle portion 72 moves toward the radially inner side since the respective projections of the support shaft 41 are inserted to the guide portions 63, 64 of the first and second carriers 61, 62. The one projection of the support shaft 41 moves toward the outer circumference side of the iris plate 70 along the throttle portion 72 when the iris plate 70 rotates in the counterclockwise direction in the plane of drawing in FIG. 4. In this case, the one projection moves toward the radially outer side by the action of the guide portions 63, 64. Thus, the support shaft 41 can radially move by the guide portions 63, 64 and the throttle portion 72. Therefore, the planetary ball 40 can perform the tilt operation. In this illustration, the iris plate 70 is rotated in the clockwise direction in the plane of drawing of FIG. 4 when tilting in the decelerating direction, and the iris plate 70 is rotated in the counterclockwise direction in the plane of drawing of FIG. 4 when titling in the speed increasing direction.

The continuously variable transmission 1 includes a torque transmitting unit 80 that rotates the first carrier 61 in cooperation with the rotation of the iris plate 70. The torque transmitting unit 80 merely needs to be able to generate the transmission torque T corresponding to the relative rotation speed V between the first carrier 61 and the iris plate 70 with each other, and for example, a rotation speed sensitive type coupling, field coupling, and the like can be used. The illustrated torque transmitting unit 80 generates the transmission torque T with the rotation of the iris plate 70 and transmits the transmission torque T to the first carrier 61 to rotate the first carrier 61. The first carrier 61 is assumed to be rotated in the circumferential direction same as the iris plate 70 herein. The torque transmitting unit 80 is arranged between the first carrier 61 and the iris plate 70, but is preferably arranged so as not to run out toward the radially outer side of the first carrier 61 and the iris plate 70. The torque transmitting unit 80 is arranged on the radially inner side than each support shaft 41 at between the first carrier 61 and the iris plate 70.

The force that acts on the planetary ball 40 and the like with the input of the torque from the power source will be described before specifically describing the torque transmitting unit 80.

For example, at the time of positive drive, the torque is input from the power source to the first rotation member 10. The description will be made below with the direction of the input torque being the same as the clockwise direction in the plane of drawing of FIG. 4 (i.e., direction of changing the transmission gear ratio γ to the decelerating side with the iris plate 70).

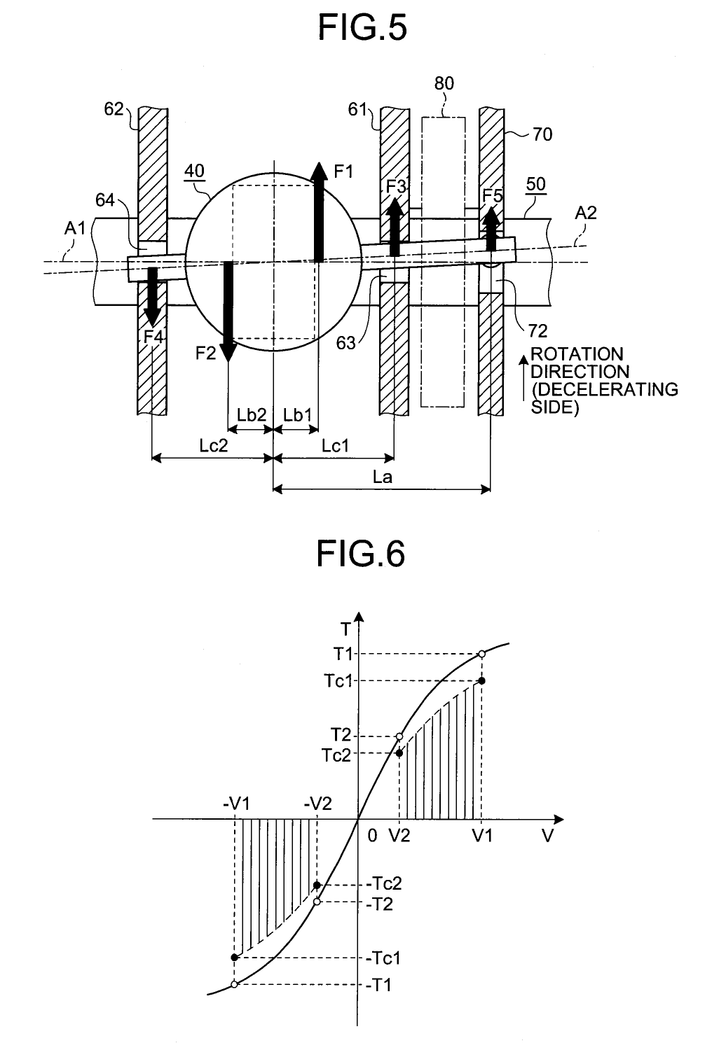

As illustrated in FIG. 5, the tangential forces (traction forces) F1, F2 in opposite directions to each other act by the input torque at the contacting point with the first and second rotation members 10, 20 in the planetary ball 40. FIG. 5 is a view of the planetary ball 40, and the like seen in the direction of the arrow B of FIG. 1, and is a partial cross-sectional view taken along the second rotation center axis A2. “F1=F2” herein. The respective contacting points are at positions deviated from the barycenter of the planetary ball 40 on the outer circumferential surface of the planetary ball 40. Thus, the respective tangential forces F1, F2 become eccentric loads in the planetary ball 40, whereby a rotation moment (hereinafter referred to as “spin moment”) having the relevant barycenter as the center generates at the planetary ball 40 when the tangential forces F1, F2 are applied. In the illustration of FIG. 5, the spin moment in the counterclockwise direction acts.

Since a clearance exists in the width direction of the first and second guide portions 63, 64 between the support shaft 41 and the first and second guide portions 63, 64, the planetary ball 40 tilts as the rotation axis deviation generates in the direction of the spin moment, as illustrated in FIG. 5. In the skew state caused by the rotation axis deviation, the forces F3, F4 corresponding to the tangential forces F1, F2 act on the portion positioned in the first and second guide portions 63, 64 of the support shaft 41 (equations 1, 2). The forces F3, F4 can be assumed as the force corresponding to the input torque from the power source. The forces F3, F4 are pressing forces in the circumferential direction with respect to the first and second guide portions 63, 64 if the support shaft 41 is brought into contact with the wall surfaces of the first and second guide portions 63, 64.

F3=(Lb1/Lc1)*F1 (1)

F4=(Lb2/Lc2)*F2 (2)

Lb1, Lb2, Lc1, and Lc2 represent the distance in a state the planetary ball 40 is seen in the direction of the arrow B of FIG. 1. “Lb1” is the distance to the barycenter of the planetary ball 40 and one contacting point (contacting point of the first rotation member 10 and the planetary ball 40). “Lb2” is the distance to the barycenter of the planetary ball 40 and the other contacting point (contacting point of the second rotation member 20 and the planetary ball 40). “Lc1” is the distance between the barycenter of the planetary ball 40 and the acting point (e.g., central portion of the support shaft 41 in the first guide portion 63) from the support shaft 41 in the first guide portion 63. “Lc2” is the distance between the barycenter of the planetary ball 40 and the acting point (e.g., central portion of the support shaft 41 in the second guide portion 64) from the support shaft 41 in the second guide portion 64. Here, “Lb1=Lb2” and “Lc1=Lc2”, and hence “F3=F4”.

Furthermore, in the skew state, a force F5 corresponding to the tangential force F1 (i.e., input torque of the power source) acts on the portion positioned in the throttle portion 72 of the support shaft 41 (equation 3). The force F5 becomes the pressing force in the circumferential direction with respect to the throttle portion 72 if the support shaft 41 is brought into contact with the wall surface of the throttle portion 72. “La” is the distance between the barycenter of the planetary ball 40 and the acting point (e.g., central portion of the support shaft 41 in the throttle portion 72) from the support shaft 41 in the throttle portion 72.

F5=(Lb1/La)*F1 (3)

The torque transmitting unit 80 of the present example sets the torque transmission property such that the absolute value of the transmission torque T becomes greater than the absolute value of the product To of the force F3 illustrated in equation 4 and the acting radius Rc (FIG. 2) of the force F3. The acting radius Rc changes according to the transmission gear ratio γ. The product Tc is the torque that acts on the first carrier 61 from the support shaft 41, and can be said as the torque that acts on the first carrier 61 by the input torque from the power source. The product Tc is hereinafter referred to as “carrier torque Tc”.

Tc=Rc*F3=Rc*(Lb1/Lc1)*F1 (4)

The carrier torque Tc is generated in the same direction regardless of whether the gear shift is to the decelerating side or the speed increasing side since the direction depends on the direction of the input torque from the power source. In the illustration, the carrier torque is generated in the same direction as the rotation direction of the iris plate 70 of when gear shifting to the decelerating side. On the contrary, the direction of the transmission torque T of the torque transmitting unit 80 is determined by the rotation direction of the iris plate 70. Thus, the transmission torque T is generated in the same direction as the carrier torque Tc at the time of gear shift to the decelerating side, and is generated in the opposite direction from the carrier torque Tc at the time of gear shift to the speed increasing side. The direction of the transmission torque T at the time of gear shift to the decelerating side is referred to as positive rotation direction, and the direction of the transmission torque T at the time of gear shift to the speed increasing side is referred to as negative rotation direction.

The input torque from the power source takes different magnitudes depending on the various conditions such as at the time of sudden acceleration and slow acceleration even for the acceleration from the same travelling state, for example. Therefore, the transmission torque T of the torque transmitting unit 80 is set so that the absolute value becomes greater than the absolute value of the carrier torque Tc at the input torques of all the conditions assumed for the actual travelling scene. Therefore, the torque transmitting unit 80 can rotate the first carrier 61 with the rotation of the iris plate 70 regardless of the magnitude of the input torque under any condition.

FIG. 6 illustrates one example of the torque transmission property of the torque transmitting unit 80. The vertical axis illustrates the transmission torque T of the torque transmitting unit 80, and the horizontal axis illustrates the relative rotation speed V of the iris plate 70 with respect to the first carrier 61. In the torque transmitting unit 80, the transmission torque T becomes zero when the relative rotation speed V is zero. With such state of zero as the boundary, the right side in the plane of drawing of FIG. 6 is the torque transmission property at the time of positive rotation of when changing the transmission gear ratio γ to the decelerating side, and the left side in the plane of drawing is the torque transmission property at the time of negative rotation of when changing the transmission gear ratio γ to the speed increasing side. The torque transmission property in which such torque transmission properties described above become symmetric is illustrated herein.

“T1” and “T2” of FIG. 6 indicate the transmission torque of the torque transmitting unit 80 at the time of sudden acceleration and slow acceleration, respectively. “Tc1” and “Tc2” indicate the carrier torque at the time of sudden acceleration and slow acceleration, respectively. “V1” and “V2” indicate the relative rotation speed of the iris plate 70 with respect to the first carrier 61 at the time of sudden acceleration and slow acceleration, respectively. These are all for the positive rotation. For the negative rotation, the above torques are expressed as “−T1”, “−T2”, and the like in FIG. 6.

At the time of sudden acceleration, the absolute value of the transmission torque T1 greater than the absolute value of the carrier torque Tc1 is set in the case of the positive rotation (V>0). In the case of the negative rotation (V<0), on the other hand, the absolute value of the transmission torque −T1 greater than the absolute value of the carrier torque −Tc1 is set. At the time of slow acceleration, the absolute value of the transmission torque T2 greater than the absolute value of the carrier torque Tc2 is set in the case of the positive rotation. In the case of the negative rotation, on the other hand, the absolute value of the transmission torque −T2 greater than the absolute value of the carrier torque −Tc2 is set. In the illustration, the absolute value of the transmission torque T between the sudden acceleration and the slow acceleration is at least set to be greater than the absolute value of the carrier torque Tc for the respective cases of positive rotation and negative rotation. This is because the region (hatching region of FIG. 6) indicates the range of moment by the gear shifting speed and the input torque assumed in the present vehicle.

According to such setting of the torque transmission property, the torque transmitting unit 80 can easily create the skew state of FIG. 5 since the transmission torque T in the same direction as the carrier torque Tc acts on the first carrier 61 thus rotating the first carrier 61 in the same direction as the carrier Tc when gear shifting to the decelerating side. This is because, in this case, the drag from one wall surface in the width direction of the first guide portion 63 to the support shaft 41 reduces with the rotation of the first carrier 61, and the generation of the skew state by the spin moment at the relevant wall surface is less likely to be inhibited.

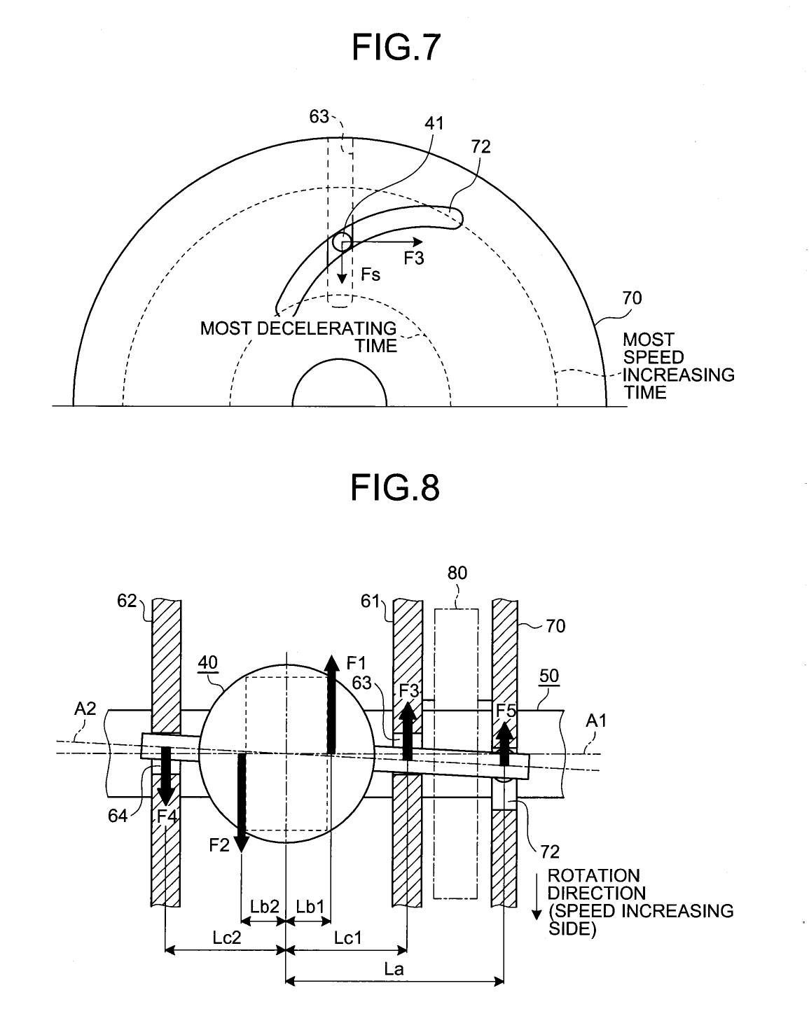

In the skew state, a deviation also occurs between the rotation direction of the sun roller 30 and the rotation direction of the planetary ball 40. Thus, a side slip speed determined by the rotation speed of the sun roller 30 and the rotation speed of the planetary ball 40 generates between the sun roller 30 and the planetary ball 40. Although the force Fa to move the sun roller 30 in the axis line direction (rightward direction in the plane of drawing in FIG. 5) acts by the side slip speed, the movement in the axis line direction of the sun roller 30 is regulated and hence the force Fa to move the sun roller 30 in the opposite direction (leftward direction in the plane of drawing of FIG. 5) generates at the planetary ball 40 in the skew state between the planetary ball 40 and the sun roller 30 as a counteraction. Since the planetary ball 40 is restricted at three points, the first and second rotation members 10, 20 and the sun roller 30, the force Fa of the counteraction becomes the force of moving the planetary ball 40 on the upper side in FIG. 1 in the clockwise direction in the plane of drawing in the figure. Furthermore, in the skew state, the direction of the vector of the tangential force F2 on the output side is tilted toward the inner side (first carrier 61 side in FIG. 5) by the deviation angle of the support shaft 41, although not specifically described in FIG. 5. A part of the tangential force F2 becomes the force Fb of geometrically rotating the planetary ball 40 on the upper side in FIG. 1 in the clockwise direction in the plane of drawing in the figure. Thus, the tangential force by the resultant force of the force Fa and the force Fb acts on the surface of the planetary ball 40 in the skew state of FIG. 5. The tangential force by the resultant force becomes the rotation moment in the clockwise direction in the plane of drawing in the figure at the planetary ball 40 on the upper side in FIG. 1, and causes the projection on the first carrier 61 side and the iris plate 70 side of the support shaft 41 to generate the skew force toward the radially inner side. FIG. 7 illustrates the skew force Fs generated at the position of the distance Lc1 in the first carrier 61. The skew force Fs becomes the tilt force of when gear shifting to the decelerating side.

In the continuously variable transmission 1, the first carrier 61 can be rotated in the same direction through the torque transmitting unit 80 and the generation of the skew state of FIG. 5 by the spin moment can be assisted by rotating the iris plate 70 to shift gears to the decelerating side. Thus, in the continuously variable transmission 1, a skew force Fs required for the gear shift to the decelerating side can be generated at the support shaft 41, and the planetary ball 40 can be tilted to the decelerating side.

In order to tilt the planetary ball 40, the magnitude of the skew force that is necessary (necessary skew force) Fs0 is determined from the standpoint of speed, efficiency and the like of the tilt operation, and the skew state (deviation angle of the support shaft 41) required for the generation of such necessary skew force Fs0 needs to be created. In the illustration, a clearance CL (FIG. 2) in the width direction of the first guide portion 63 between the support shaft 41 and the first guide portion 63 is set based on the maximum value Smax of the necessary skew amount in the first guide portion 63 necessary for the generation of the necessary skew force Fs0. The clearance CL is set such that the relationship with the maximum value Smax of the necessary skew amount satisfies the relational expression of equation 5 below. The skew amount of the first guide portion 63 is the movement amount of the support shaft 41 in the first guide portion 63 involved in the generation of the skew, and for example, a rough value can be estimated from the deviation angle of the support shaft 41 and the distance Lc1. In the illustration, the clearance LC with the support shaft 41 in the second guide portion 64 is also set to the same magnitude.

CL/2≧Smax (5)

When changing the transmission gear ratio γ to the speed increasing side, the iris plate 70 is rotated so that a force in the opposite direction from the force F3 and the force F5 acts. In the continuously variable transmission 1, the transmission torque T in the opposite direction from the carrier torque Tc acts on the first carrier 61 through the torque transmitting unit 80 with the rotation of the iris plate 70. Since the absolute value of the transmission torque T is greater than the absolute value of the carrier torque Tc, the first carrier 61 rotates in the opposite direction from the carrier torque Tc. At the same time as the rotation of the first carrier 61, the wall surface of the first guide portion 63 presses and moves the support shaft 41 in the opposite direction from the spin moment, and thus the planetary ball 40 is in the skew state in the opposite direction from the skew state of FIG. 5, as illustrated in FIG. 8.

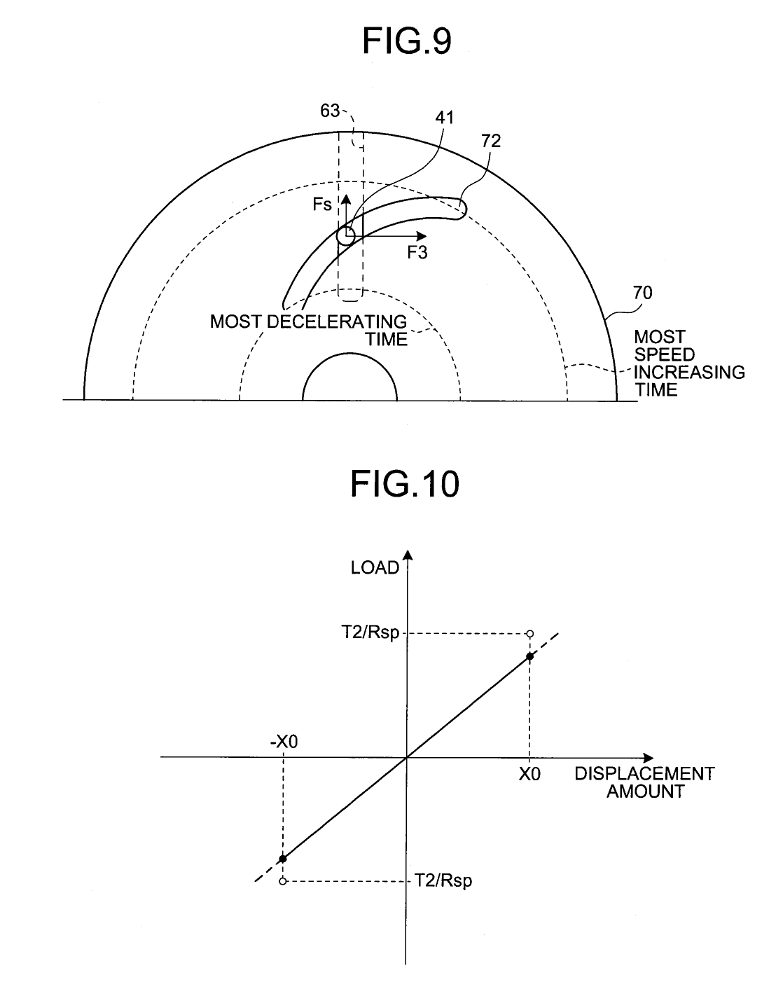

At the time of gear shift to the speed increasing side, a force Fa between the sun roller 30 and the planetary ball 40 of counteraction generates as directed the rightward direction in the plane of drawing of FIG. 8 by creating the skew state opposite from that of the decelerating side. The force Fa becomes the force of moving the planetary ball 40 on the upper side of FIG. 1 in the counterclockwise direction in the plane of drawing of the figure. Furthermore, in this skew state, the direction of the vector of the tangential force F2 on the output side is tilted to the outer side (the second carrier 62 side in FIG. 8) by the amount of deviation angle of the support shaft 41, although not specifically described in FIG. 8. A part of the tangential force F2 becomes the force Fb of geometrically rotating the planetary ball 40 on the upper side in FIG. 1 in the counterclockwise direction in the plane of drawing of the figure. At the time of gear shift to the speed increasing side, the tangential force by the resultant force of the force Fa and the force Fb acts on the surface of the planetary ball 40, thus acting the rotation moment in the counterclockwise direction in the plane of drawing of the figure on the planetary ball 40 on the upper side in FIG. 1. The rotation moment causes the projection on the first carrier 61 side and the iris plate 70 side of the support shaft 41 to generate the skew force directed toward the radially outer side. FIG. 9 illustrates the skew force Fs generated at the position of the distance Lc1 in the first carrier 61. The skew force Fs becomes the tilt force of when gear shifting to the speed increasing side.

In the continuously variable transmission 1, the first carrier 61 is also rotated in the same direction through the torque transmitting unit 80, and the generation of the skew state in the opposite direction from the decelerating side can be assisted by rotating the iris plate 70 so as to shift gears to the speed increasing side. Thus, in the continuously variable transmission 1, the skew force Fs necessary for the gear shift to the speed increasing side can be generated at the support shaft 41, and the planetary ball 40 can be tilted to the speed increasing side.

As described above, the elastic member 66 is arranged in the two clearances formed between the groove portion 65 of the first carrier 61 and the projection 51 of the shaft 50. Thus, the force by the elastic force of the elastic member 66 also acts on the acting point of the force F3 in the first carrier 61. Therefore, at the time of gear shift to the speed increasing side, in particular, the force by the elastic force inhibits the rotation of the first carrier 61 and it may become difficult to rotate the first carrier 61 with the torque transmitting unit 80 until the planetary ball 40 becomes the skew state of FIG. 6 from the reference position. In the continuously variable transmission 1, the property (spring constant) of the elastic member 66 is set as illustrated in FIG. 10. The elastic member 66 sets the property so that the torque transmitting unit 80 can rotate the first carrier 61 even in slow acceleration when gear shifting to the speed increasing side. Specifically, since the torque transmitting unit 80 at the time of slow acceleration generates the transmission torque T2, the property of the elastic member 66 is set so as to obtain the maximum displacement amount X0 with a load smaller than the load (T2/Rsp) by the transmission torque T2 based on the load (T2/Rsp) acting on the elastic member 66 and the maximum displacement amount X0 of the elastic member 66 in the clearance. The “Rsp” is the acting radius of the elastic member 66 (FIG. 2). Thus, in the continuously variable transmission 1, the rotation of the first carrier 61 necessary for the generation of the skew state can be enabled with the transmission torque T of the torque transmitting unit 80.

As described above, the continuously variable transmission 1 can create the skew state of the planetary ball 40 suited for the gear shift to the decelerating side or the speed increasing side under various situations by arranging the torque transmitting unit 80 between the first carrier 61 and the iris plate 70. In this case, the first carrier 61 is rotated at the transmission torque T of the torque transmitting unit 80 generated by the rotation of the iris plate 70. Thus, in the continuously variable transmission 1, a dedicated drive source for rotating the first carrier 61 is not necessary and only the drive source (motor MG) for rotating the iris plate 70 needs to be arranged, so that the transmission is miniaturized and the gear shifting energy necessary for the gear shift is reduced compared to the conventional art in which a motor for the first carrier 61 is also arranged. Furthermore, in the continuously variable transmission 1, the torque transmitting unit 80 is to be arranged in the existing clearance between the first carrier 61 and the iris plate 70, and the clearance does not need to be greatly widened even if widening is necessary, so that the torque transmitting unit 80 can be arranged while suppressing the enlargement of the transmission.

The illustrated torque transmitting unit 80 is set to the same torque transmission property for the positive rotation and the negative rotation, but may be set to different torque transmission properties for the positive rotation and the negative rotation. In such a case, for example, the transmission torque T of the positive rotation, which is the same direction as the carrier torque Tc, can be made smaller than that of the negative rotation.

### REFERENCE SIGNS LIST

1 continuously variable transmission
10 first rotation member (first rotation element)
20 second rotation member (second rotation element)
30 sun roller (third rotation element)
40 planetary ball (rolling member)
41 support shaft
50 shaft (transmission shaft)
51 projection
61 first carrier (first holding member)
62 second carrier (second holding member)
63 first guide portion
64 second guide portion
65 groove portion
66 elastic member
70 iris plate (tilt element)
72 throttle portion
80 torque transmitting unit
MG motor

1. A continuously variable transmission comprising:
a transmission shaft as a fixing shaft serving as a rotation center;
a first rotation element and a second rotation element configured to be rotatable relatively, arranged facing each other on the transmission shaft and have a common first rotation center axis;
a rolling member configured to have a second rotation center axis parallel to the first rotation center axis, arranged radially in plurals with the first rotation center axis as a center, and sandwiched between the first rotation element and the second rotation element;
a support shaft of the rolling member configured to have the second rotation center axis and both ends of the support shaft projecting out from the rolling member;
a third rotation element configured to arrange the each rolling member on an outer circumferential surface, and arranged to be rotatable relatively with respect to the transmission shaft as well as the first rotation element and the second rotation element;
a first holding member arranged to be rotatable relatively with the first rotation center axis as the center with respect to the transmission shaft, and formed with a first guide portion that guides one projection of the each support shaft in a radial direction;
a second holding member fixed to the transmission shaft and formed with a second guide portion that guides the other projection of the each support shaft in the radial direction;
a tilt element configured to include a throttle portion that has an intersection point intersecting with the first guide portion when seen in an axis line direction and that holds one projection of the support shaft at the intersection point, and configured to move the intersection point in the radial direction by rotating relatively with the first rotation center axis as the center with respect to the transmission shaft;
an actuator configured to rotate relatively the tilt element with respect to the transmission shaft; and
a torque transmitting unit configured to generate a transmission torque between the first holding member and the tilt element corresponding to a relative rotation speed between the first holding member and the tilt element.

2. The continuously variable transmission according to claim 1, wherein
the torque transmitting unit sets a transmission torque greater than a product of a force to the first holding member from the support shaft corresponding to an input torque and an acting radius of the force.
